(19) United States
(12) Patent Application Publication
(10) Pub. No.: US 2015/0287137 A1
(43) Pub. Date: Oct. 8, 2015

(54) SYSTEMS AND METHODS FOR DETERMINING A FINANCIAL HEALTH INDICATOR

(71) Applicant: BANK OF AMERICA CORPORATION, Charlotte, NC (US)

(72) Inventors: Kazi M. Ariff, Quincy, MA (US); Carol A. Smith, Edgartown, MA (US); Shane A. Johnson, Charlotte, NC (US); Russell W. Tipper, Boston, MA (US); Yicong Li, Lexington, MA (US); Sean M. O'Connor, Scituate, MA (US); Thomas D. Kelley, Hingham, MA (US); Susan S. Thomas, Gastonia, NC (US); William F. Borowski, Millbury, MA (US); William J. Aheron, Charlotte, NC (US); Judith M. Anderson, East Walpole, MA (US); Steven K. Hayes, Bemus Point, NY (US); Neal G. Wolfson, Lexington, MA (US); Jeffrey P. Judd, Boston, MA (US); James P. Kirkman, Acton, MA (US); Jeffrey H. Bierer, Charlotte, NC (US)

(73) Assignee: BANK OF AMERICA CORPORATION, Charlotte, NC (US)

(21) Appl. No.: 14/247,010

(22) Filed: Apr. 7, 2014

(51) Int. Cl. G06Q 40/02

(52) U.S. Cl. CPC G06Q 40/025

(57) ABSTRACT

Systems, methods, and computer program products are provided for providing a financial health indicator based on the user's credit report score and the user's budget indicator. Implemented in conjunction with a budget tracking system, the invention may provide financial health indicators indicating both short-term budget impact and long-term budget impact. In addition, certain embodiments provide for recognizing recurring expenditures and automatically providing the user with the budget impact of such recurring expenditures as a financial health indicator.

### FIELD

In general, embodiments herein disclosed relate to systems, methods, and computer program products for a financial health indicator, and more specifically, determining a financial health indicator based on the user's credit report score and the user's budget indicator.

### BACKGROUND

In general, most individuals have a difficult time saving money. This problem is evident in the United States where the national average personal savings rate has recently moved from the positive to the negative for the first time since the Great Depression, meaning Americans are spending more than they are saving. While statistics show that 78 million Americans will retire in the next 20 years, long-term financial planning and retirement goals for the vast majority of these individuals are cast in doubt by the inability to save.

Furthermore, problems associated with inadequate savings not only affect long-term retirement plans, but also come to the forefront during prolonged recessionary periods, such as the global recession currently being experienced. With individuals being displaced from their employment at alarming rates, these individuals need to call on their short-term savings as a means of support in the interim. In this regard, the need to address the savings problem takes on a sense of urgency.

However, admitting a savings problem and doing something about it are not one in the same. Saving money requires an individual to budget properly and, for whatever reason, be it unwillingness, inability or the like, individuals have shown a proven tendency not to budget properly. This problem is exasperated in a downturned economy in which a whole new sector of the population must accept at least a slight decrease, and in some instances a significant decrease, in their standard of living. Thus, the need to budget, and moreover budget effectively, becomes imperative.

Currently, many commercial applications exist that assist individuals with budgeting. For example, Microsoft® Money, available from Microsoft Corporation of Redmond, Wash. and Intuit® Quicken®, available from Intuit Incorporated of Mountain View, Calif. are two such commercially available budget applications. However, these applications may be limited in the data resources they have available to assess a user's current budget allocation and determine or make recommendations for a user's target budget allocation. Moreover, these applications may be limited in terms of the data resources they have available to automatically track an individual's spending, i.e., the individual's ability to stay on budget. In addition to possible data resource limitations, the corporations that provide these applications are not in the business of providing their users with financial planning and/or financial advice and, therefore, do not employ a staff dedicated to ensuring their users financial security. Therefore, when using these types of commercial budget applications, the user is on their own when it comes to making financial decisions that affect their budget, short-term savings and/or long-term savings.

Additionally, known budgeting applications do not possess the ability to ensure that users adhere to their assigned budgets. In this regard, the commercial entities that provide such applications are not in a position to reward and/or penalize users that are successful or fail to stay on budget. In addition, currently existing budgeting applications do not possess the ability to provide the user a comprehensive and dynamic financial health indicator that takes into account various factors that cumulatively affect the user's overall financial health.

In addition, current budgeting applications do not provide for a spending deterrence. In this regard, current budgeting applications do not assess the budget ramifications of proposed expenditures, recurring expenditures or cost adjustments to fixed expenditures, such as rent, house payment, automobile payment and the like.

Up until now, financial institutions have been focused on providing their customers with investment services, loan services and the like. However, by shifting the financial institution mindset from an investment strategy to a budget strategy, these institutions, such as banks and the like, can capitalize on an increase in customer assets (i.e., savings), an increase in customer retention, and lower the credit risk for their customer base. Additionally, financial institutions have the ability to leverage instrumental budget-related data that may be otherwise unavailable to other commercial entities providing budget applications.

Therefore, a need exists to develop systems, methods, apparatus, computer program products and the like for an improved budgeting system. In this regard, the budget system should improve upon the accuracy of the determination of the user's current budget allocation and provide for a more comprehensive and focused means for determining and/or recommending a target budget allocation to the user. In addition, desired systems, methods, apparatus, computer program products and the like should provide for a better means to ensure that the user stays on track in terms of their budget allocation and a means to reward and/or penalize the user if they do/do not stay on their budgeting track. Additionally, the desired systems, methods, apparatus, computer program products and the like should provide for a dynamic tool that indicates how well a user is doing in regards to meeting their budget, making improvements in savings and/or improving their overall creditworthiness. Moreover, the desired systems, methods, apparatus, computer program products and the like should provide for a spending deterrence that affectively limits the amount of spending incurred by the user, thereby further assisting the user in adhering to their respective target budget allocation.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are defined that provide for financial health indicators in the form of dynamic determination of the budget impact on expenditures, such as expenditures, potential expenditures, cost adjustments and the like. Implemented in conjunction with a budget tracking system, the budget impact determiner of the present invention may provide financial indicators for both short-term budget impact, such as a month, quarter, year or the like and long-term budget impact, such as terms greater than a year. The budget impact determiner of the present invention is applicable to be executed or otherwise accessed on any computing platform and, in particular on portable devices, such as cellular phones and the like for the purpose of determining budget impact on-demand. For example, if a user is contemplating the expenditure of item or service and wants to determine the short-term and/or long-term budget implication of the expenditure. In this regard, by implanting the budget impact determiner of the present invention, the user may be deterred from making impulse expenditures or any other extraneous expenditure. In addition the budget impact determiner can readily assess the budget impact of cost adjustments, such as increases/decreases in rent or mortgage and/or increases/decrease in automobile payments and the like.

In one specific embodiment of the present invention, the budget impact determiner may be capable of automatically identifying recurring expenditures. For example, if a user makes continual daily expenditures at a coffee shop or the like. Based on the identification of the recurring expenditures, a determination of the budget impact may automatically occur and the user may be automatically communicated or otherwise presented with the results of the budget impact determination. In this regard, the budget impact of small amount expenditures that occur continually is provided to the user who may be unaware of the ability to create significant savings, and especially long-term savings, if the recurring expenditure is eliminated or otherwise lessened.

According to one embodiment of the invention, a method is defined for budget impact determination in a comprehensive budget tracking system. The method includes activating a budget impact determination application, and receiving, at the budget impact determination application, an expenditure amount input. The method further includes determining a budget impact for the expenditure amount input and providing the determined budget impact to a user associated with the expenditure.

According to one embodiment of the method, determining a budget impact further includes determining a savings amount based on foregoing the expenditure. In further embodiments of the method, determining a budget impact may further include determining a short-term and/or long-term budget impact for expenditure based on the user's predefined target budget allocation. The short-term budget impact may be defined as a time period of less than a year, typically a month or less and the long-term budget impact may be defined as a time period of a year a more.

Additionally, according to other embodiments of the method, receiving an expenditure amount may further include receiving a proposed expenditure amount prior to making a purchase, receiving an expenditure amount after making a purchase, receiving a cost adjustment amount, either a cost increase or cost decrease, for a pre-existing and continual payment, such as mortgage, rental or loan payment.

According to one specific embodiment, the method may further include determining a recurring expenditure made by the user, such as a frequent or daily purchase at one particular retail outlet or the like. In such embodiments, activating the budget impact determination application may further include automatically activating the budget impact determination application based on determination of the recurring expenditure. Further, in such embodiments, receiving an expenditure amount input further includes receiving, automatically, an expenditure amount associated with the recurring expenditure. As such, the budget impact determination application may automatically provide the user with the budget impact for expenditures that have been determined to be recurring expenditures.

An apparatus for budget impact determination in a budget tracking system defines another embodiment of the invention. The apparatus includes a computer platform including at least one processor and a memory. The apparatus also includes a budget module stored in the memory, executable by the processor and operable to track expenditures for users. The budget module includes a budget impact determination application operable to receive an expenditure amount input, determine a budget impact for the expenditure amount input and provide the determined budget impact to a user associated with the expenditure amount.

In accordance with optional embodiments of the apparatus, the budget impact determination routine is further operable to determine a savings amount based on foregoing the expenditure amount. Moreover, according to certain embodiments, the budget impact determination application is further operable to determine a short-term and/or a long-term budget impact for the expenditure based on a predefined target budget allocation associated with the user.

Further, other embodiments of the apparatus provide for the budget impact determination application to be operable to receive a manual input of a proposed expenditure amount prior to making the expenditure, receive a manual or automated input of an expenditure amount after making an expenditure, receive a cost adjustment, either a cost increase or cost decrease, for a pre-existing and continual payment, such as mortgage, rental or loan payment or the like.

According the one specific embodiment of the apparatus, the budget module may further include a recurring expenditure determination application operable to determine recurring expenditures made by the user. In such embodiments, the budget impact determination application may be further operable to be activated, automatically, based on the determination of the recurring expenditure and receive, automatically, the expenditure amount associated with the recurring expenditure, such that the budget impact of the recurring expenditure is determined automatically and presented to the user automatically.

A computer program product defines yet another embodiment of the invention. The computer program product includes a computer-readable medium. The medium includes a first set of codes for causing a computer to receive an expenditure amount input to a budget impact determination application. The medium also includes a second set of codes for causing a computer to determine a budget impact for the expenditure amount input and a third set of codes for causing a computer to provide the determined budget impact to a user associated with the expenditure amount.

Thus, methods, systems, computer program products and the like are described in detail herein, which provide for budget impact determination for expenditures being made or contemplated by a user of budget tracking system. The budget impact determination application is made readily available to users on-demand either via a budget tracking website or executable on the user's device as a widget in dashboard-type application. The on-demand aspect of the budget impact determination application allows for the user to determine both short-term and long-term budget implications prior to making a purchase. In this regard, a user may be deterred from making impulse purchases that would negatively impact the user's target budget allocation.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram depiction of a system for budget tracking, according to an embodiment of the present invention;

FIG. 2 is a block diagram depiction illustrating an apparatus configured to provide for budget impact determination in a budget tracking system, in accordance with embodiments of the present invention;

FIG. 3 is a more detailed block diagram of an apparatus configured for providing a budget tracking system, in accordance with an embodiment of the present invention;

FIG. 4 is a flow diagram of a method for determining budget impact for budget system user expenditures, in accordance with an embodiment of the present invention;

FIG. 5 is a flow diagram detailing a method for determination and/or selection of a target budget allocation and associated budget guardrails, in accordance with present embodiments;

FIG. 6 is a flow diagram of a method for tracking budget expenditures and, in particular tracking user-defined budget guardrails, in accordance with present embodiments;

FIG. 7 is a flow diagram of a method for determining a financial health indicator, in accordance with present embodiments; and

FIG. 8 is a flow diagram of a method for determining budget impact, in accordance with yet another embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Methods, systems and computer program products are defined that provide for the dynamic determination of the budget impact on expenditures, such as expenditures, potential expenditures, cost adjustments and the like. Implemented in conjunction with a budget tracking system, the budget impact determiner of the present invention may provide for both short-term budget impact, such as a month, quarter, year or the like and long-term budget impact, such as terms greater than a year. The budget impact determiner of the present invention is applicable to be executed or otherwise accessed on any computing platform and, in particular on portable devices, such as cellular phones and the like for the purpose of determining budget impact on-demand. For example, if a user is contemplating the expenditure of item or service and wants to determine the short-term and/or long-term budget implication of the expenditure. In this regard, by implanting the budget impact determiner of the present invention, the user may be deterred from making impulse expenditures or any other extraneous expenditure. In addition the budget impact determiner can readily assess the budget impact of cost adjustments, such as increases/decreases in rent or mortgage and/or increases/decrease in automobile payments and the like.

In one specific embodiment of the present invention, the budget impact determiner may be capable of automatically identifying recurring expenditures. For example, if a user makes continual daily expenditures at a coffee shop or the like. Based on the identification of the recurring expenditures, a determination of the budget impact may automatically occur and the user may be automatically communicated or otherwise presented with the results of the budget impact determination. In this regard, the budget impact of small amount expenditures that occur continually is provided to the user who may be unaware of the ability to create significant savings, and especially long-term savings, if the recurring expenditure is eliminated or otherwise lessened.

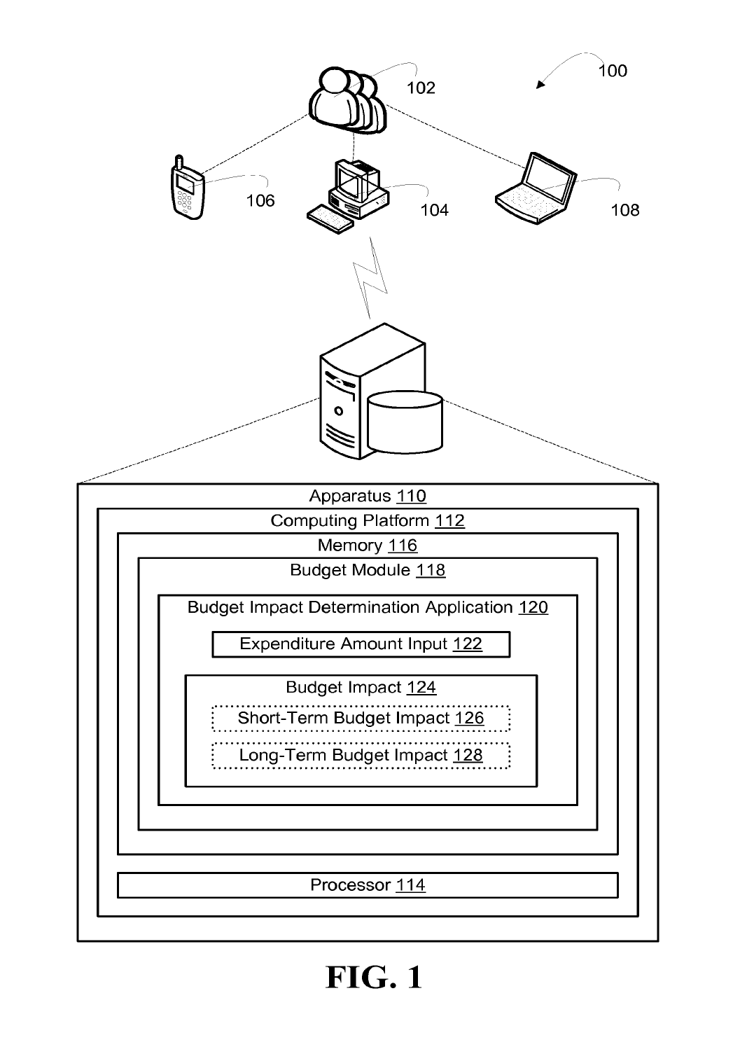

Referring to FIG. 1, a block diagram is depicted of a budget tracking system 100 that provides for a user 102 to access the system wirelessly or otherwise, to track their budget from any networked device, such as a PC 104, or a portable device, such as cellular telephone 106 or laptop computer 108. In one embodiment, the budget system 100 may be a web-based system that is accessible to users 102 through a budget system provider's web site or the like. In one particular embodiment, in which the budget tracking system is implemented by a financial institution, such as a bank, the budget system may be accessible to the user through the financial institution's online banking site or the like.

The budget tracking system 100 also includes an apparatus 110, which may include multiple devices, for executing the budget tracking system 100 and, in particular, an apparatus configured for providing budget impact determination, in accordance with an embodiment of the invention. The apparatus 110 includes a computing platform 112 having at least one processor 114 and a memory 116. The memory 116 includes a budget module 118 that is operable to implement a budget tracking system that includes, but is not limited to providing for determination of budget impact based on user expenditures or proposed expenditures.

According to embodiments of the presently described invention, the budget module 118 includes a budget impact determination application 120 that is operable to determine the budget impact for user's expenditures. The budget impact determination application may be accessible to the user via an online website or the budget impact determination application may be a downloadable entity, such as a budget impact determiner widget (not shown in FIG. 1) that may be stored and executed on a user's device. In either instance the budget impact determination application 120 should be readily accessible to user's via a handheld device, such as a cellular device, personal data assistant (PDA) or the like. In this regard the budget system user can access the budget impact determination application 120 on-demand, such as, for example, at a point-of-sale in a retail outlet to dynamically assess the budget impact of a proposed expenditure.

The budget impact determination application 120 is capable of determining the budget impact of any user expenditure including, but not limited to, proposed or contemplated purchases, purchases already consummated, adjustments (either increases or decreases) in cost to ongoing payments, such as mortgages, rents, loan payment and the like.

According to embodiments herein disclosed, the budget impact determination application 120 provides for an expenditure amount input 122 that may be manually inputted by the user prior to, during or after an expenditure. Based on the inputted expenditure amount the budget impact determination application 120 determines a budget impact 124, which may be a savings amount based on foregoing the expenditure or the like. According to specific embodiments of the invention, the budget impact may include a short-term budget impact 126 and/or a long-term budget impact 128. The short-term budget impact may be for a time period less than a year, typically a month or less and the long-term budget impact may be for a time period of a year or more.

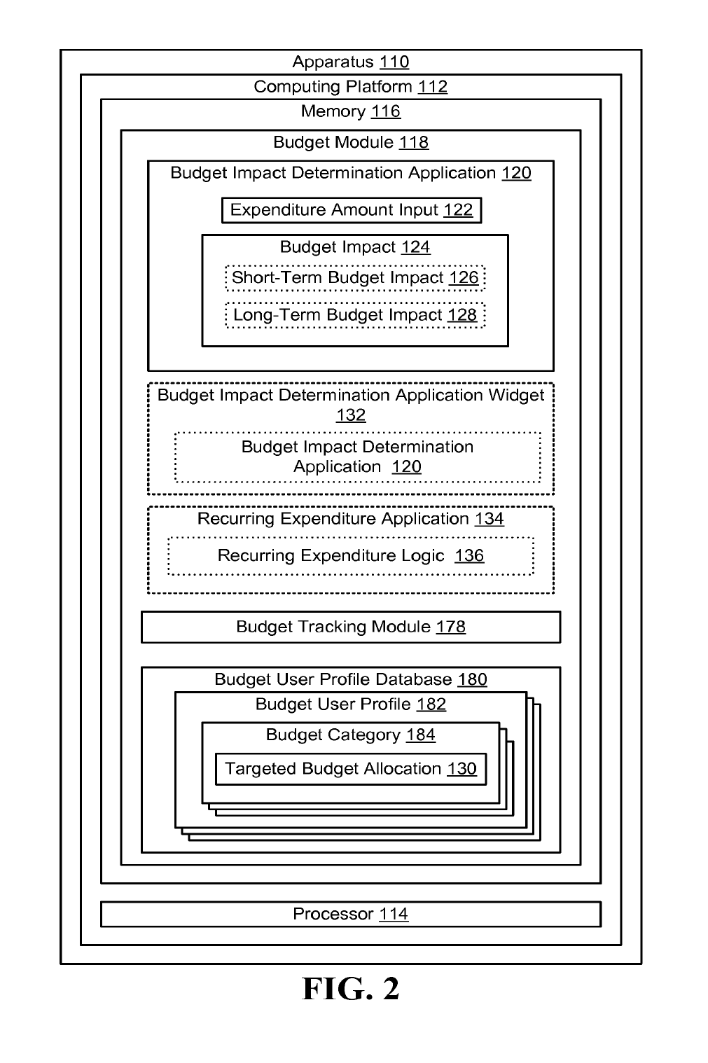

Turning the reader's attention to FIG. 2, a more detailed block diagram of apparatus 110 is depicted that highlights various optional embodiments of the budget allocation module 120. As previously noted, apparatus 110, which may comprise more than one device, includes a computing platform 112 having a memory 116 and at least one processor 114. The memory 116 stores a financial institution-implemented budget module 118 that is operable to provide a comprehensive budgeting system for financial-institution customers/users.

As previously noted, budget module 120 includes budget impact determination application 120 that is operable to determine the budget impact for user's expenditures. The budget impact determination application may be accessible to the user via an online website or the budget impact determination application may be a downloadable entity. For example, the budget impact determination application 120 may be included in a budget impact determination application widget 132 that may be accessible and downloadable via a budget system-provider website or the like. It should be noted that the budget impact application widget 132 is not limited to being loaded on a user's device via network download and may also be loaded via physical storage media, such as compact disc (CD) or the like. If the budget impact determination application 120 is accessible via a website, any budget system user device that has Internet connectivity may access any utilize the budget impact determination application. Likewise, if the user loads the budget impact determination application 120 on one or more of their devices, the user will have access to the application regardless of the device's network connectivity capability.

According to embodiments herein disclosed, the budget impact determination application 120 provides for an expenditure amount input 122 that may be manually inputted by the user prior to, during or after an expenditure. Based on the inputted expenditure amount the budget impact determination application 120 determines a budget impact 124, which may be a savings amount based on foregoing the expenditure or the like. According to specific embodiments of the invention, the budget impact may include a short-term budget impact 126 and/or a long-term budget impact 128. The short-term budget impact may be for a time period less than a year, typically a month or less and the long-term budget impact may be for a time period of a year or more.

In order to determine budget impact, the budget impact determination application 120 may access the budget user profile database 180, which stores a plurality of budget user profiles 182. Each budget user profile 182 includes a plurality of budget categories 184, such as housing, food, travel, entertainment and the like and each category 184 has a target budget allocation 130 that has been determined for or selected by the user. The target budget allocation may reflect either or both of a short-term budget limit for the category and/or a long-term budget allocation for the category. In this regard, the budget impact determination application 120 may access the user's profile 182 to determine the target budget allocation 130 for the category of budget impact interest.

In addition, in order to determine budget impact, the budget impact determination application 120 may access the budget tracking module 178 to determine the user's current expenditures in the category of interest for a budgetary period. The current expenditures in the category are used as the baseline in determining the impact of further expenditures in the category.

According to alternate embodiment of the invention, the budget system module 118 may additionally include a recurring expenditure determination application 134 that includes recurring expenditure logic 136 operable to automatically determine recurring user expenditures. The logic 136 may be able to track automated purchases, such as debit or credit purchases or the user's manual expenditures, such as cash transactions, that the user inputs into the budget tracking system. If the logic determines that an expenditure is recurring based on an expenditure occurring at the same location a predetermined number of times within a predetermined specified period of time, the recurring expenditure determination application 134 communicates the recurring expenditure and the recurring expenditure amount or proximate amount to the budget impact determination application 120. For example, a frequent or daily purchase at a convenient store, coffee shop or the like.

In one embodiment of the invention, the acknowledgement of a recurring expenditure by the budget impact determination application 120 may cause the application 120 to automatically activate, automatically input the recurring expenditure amount and automatically determine the budget impact of the recurring expenditure amount. In this regard, the user of the budget system may be automatically provided the budget impact of expenditures determined to be recurring purchases. This type of expenditure is typically overlooked by the budget user who is unaware of not only the short-term budget impact of such expenditures but probably more importantly the long-term budget impact of such expenditures.

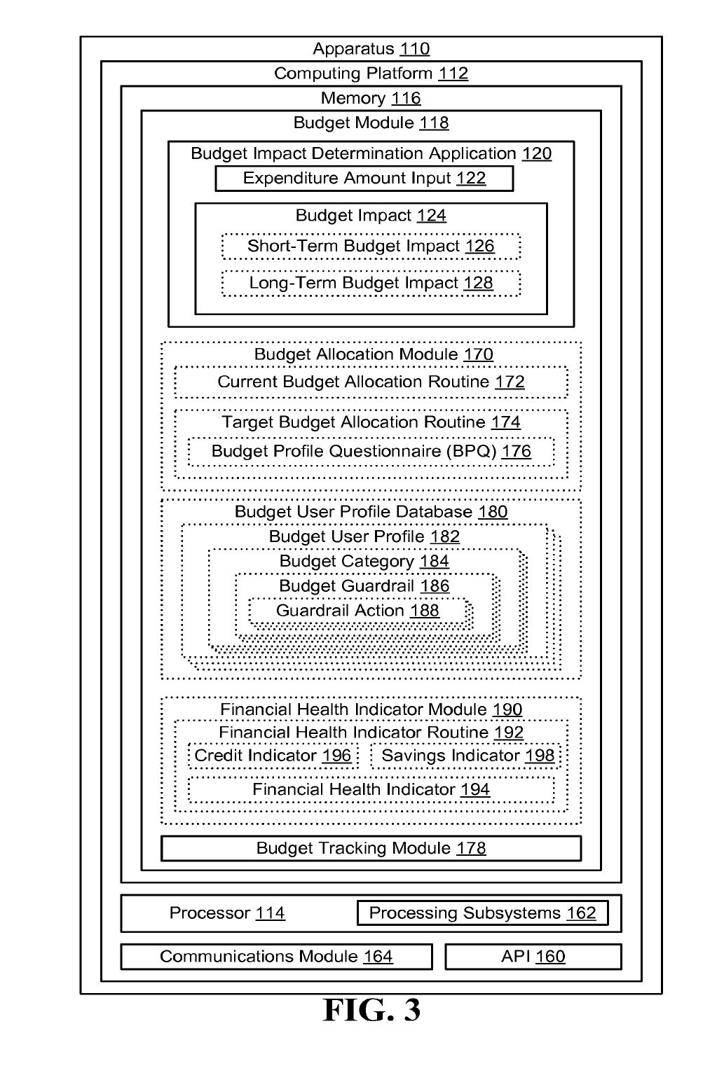

Referring to FIG. 3, a more detailed block diagram is depicted of apparatus 110 that highlights various additional aspects of the budget system 100 herein disclosed. The apparatus 110 may include any type of one or more computerized, communication devices, such as a server, a personal computer, a portable computer, or any device or devices that include a computing platform and have a wired and/or wireless connection to a network or the Internet.

The apparatus 110 includes computing platform 112 that can transmit data across a network, and that can receive and execute routines and applications. Computing platform 112 includes memory 116, which may comprise volatile and non-volatile memory such as read-only and/or random-access memory (RAM and ROM), EPROM, EEPROM, flash cards, or any memory common to computing platforms. Further, memory 116 may include one or more flash memory cells, or may be any secondary or tertiary storage device, such as magnetic media, optical media, tape, or soft or hard disk.

Further, computing platform 112 also includes processor 114, which may be an application-specific integrated circuit (“ASIC”), or other chipset, processor, logic circuit, or other data processing device. Processor 114 or other processor such as ASIC may execute an application programming interface (“API”) 160 that interfaces with any resident programs, such as budget module 118 stored in the memory 116 of the apparatus 110.

Processor 114 includes various processing subsystems 162 embodied in hardware, firmware, software, and combinations thereof, that enable the functionality of apparatus 110 and the operability of the apparatus 110 on a network. For example, processing subsystems 162 allow for initiating and maintaining communications, and exchanging data, with other networked devices. For the disclosed embodiments, processing subsystems 162 of processor 114 may include any subsystem used in conjunction with budget module 118.

Computing platform 112 additionally includes communications module 164 embodied in hardware, firmware, software, and combinations thereof, that enables communications among the various components of the apparatus 110, as well as between the apparatus 110 and an external network, such as the Internet or the like. In described embodiments, the communication module 164 enables the communication of all correspondence between apparatus 110 and other computing devices, such as user devices, 104, 106 and 108 (shown in FIG. 1).

As previously noted and discussed, the memory 116 of computing platform 112 includes the budget module 118 which includes a budget impact determination application 120 that is operable to determine the budget impact for user's expenditures. The budget impact determination application may be accessible to the user via an online website or the budget impact determination application may be a downloadable entity, such as a budget impact determiner widget (shown in FIG. 2) that may be stored and executed on a user's device.

According to embodiments herein disclosed, the budget impact determination application 120 provides for an expenditure amount input 122 that may be manually inputted by the user prior to, during or after an expenditure. Based on the inputted expenditure amount the budget impact determination application 120 determines a budget impact 124, which may be a savings amount based on foregoing or limiting the expenditure or the like. According to specific embodiments of the invention, the budget impact may include a short-term budget impact 126 and/or a long-term budget impact 128.

The budget module 118 may also include budget allocation module 170 that is operable to provide for determining a target budget allocation for a financial institution customer based on current budget allocation and user responses to a budget profile questionnaire (BPQ) or allowing a user to select a target budget based on peer data recommendations. As such, budget allocation module 170 includes a current budget allocation routine 172 operable to provide for the user's current budget allocation and a target budget allocation routine 174 that is operable to provide for the target budget allocation based on the current budget allocation and user responses to BPQ 176.

Optional embodiments of the apparatus may provide for the budget module 118 to include user-defined budget guardrails and actions associated with the defined guardrail. In this regard, budget user profile database 180 may store a plurality of budget user profiles 182. Each budget user profile 182 may define a plurality of user-defined or budget system-defined budget categories 184, such as housing, food, entertainment, transportation and the like. Each budget category 184 may provide for one or more user-defined budget guardrails 186 and each guardrail will have one or more related guardrail actions 188. A guardrail is a user defined spending limit that upon either being met or proximate to being met, depending on system or user configuration, prompts the occurrence of the user defined or system defined guardrail action. As such, budget tracking module 178 is operable to track the expenditures made by the user and initiate the defined guardrail action if a user's pre-defined guardrail spending limit has been met or is proximate to being met.

According to one embodiment, the user may define a budget guardrail 186 at the target budget allocation limit for a predefined category, or at any desired spending limit at or above the target budget allocation for a given category.

In one embodiment of the invention, the guardrail action may be a guardrail alert that is communicated to the customer to inform them that they have met a guardrail limit or are proximate to a guardrail limit. According to one embodiment, the user may configure the communication mechanism used to communicate the alert, such as an email, a SMS/text message, voice mail or the like. Additionally, according to another embodiment, the user may configure the frequency at which the alerts are communicated to the user. For example, alerts may be communicated more frequently the closer the user gets to a guardrail, or the closer the user gets to a target budget allocation category limit.

In another embodiment of the invention, the guardrail action may be a guardrail penalty that is enforced against the user if the user exceeds the spending limit of a guardrail. Since the guardrail actions are generally customer defined, the associated guardrail penalties are self-imposed penalties. A guardrail penalty may include, but is not limited to, forbidding further electronic purchases in the associated budget category until a new budget period starts. In this regard, credit or debit purchases may be denied for products/services associated with the budget category. Additionally, a guardrail penalty may include, but is not limited to, an automatic designation of funds to a restricted savings account, an automatic transfer designation of funds to a charitable organization or the like.

Other embodiments of the budget module 118 may provide for a financial health indicator module 190 that is operable to dynamically determine and provide to the user an indicator of a user's financial health. In this regard, the financial health indicator module 190 may include a financial health indicator routine 192 that is operable to determine a financial health indicator 194 of the user's financial health based on a credit indicator 196 and a budget indicator 198. The credit indicator 196 may be one or more credit scores as provided by a credit reporting bureau. A financial institution implementing the budget system of the present invention generally has access to a customer's credit score(s). According to one embodiment, the financial health indicator routine 192 may dynamically track the customer's/user's credit scores to provide for a credit indicator/score. The budget indicator 198 may be determined based on budget tracking accomplished via budget tracking module 178. By constantly tracking a budget indicator 198 and a credit indicator 196, the resulting financial health indicator 194 is a dynamic indicator that accurately reflects the financial health of the user at any point in time. The financial health indicator 194 may be in a form that indicates the user's financial health, such as, but not limited to, a numerical score, an alphabetic grade, a color on a color scale or the like.

The financial health indicator 194 may be communicated or otherwise provided to the user based on budget system configuration and/or user configuration. In one embodiment, the financial health indicator 194 may be provided as a widget running on a dashboard-type application, such that the financial health indicator 194 is dynamically accessible to the user from any networked device, such as a personal computer, laptop computer or a hand-held device, such as a cellular telephone device or the like.

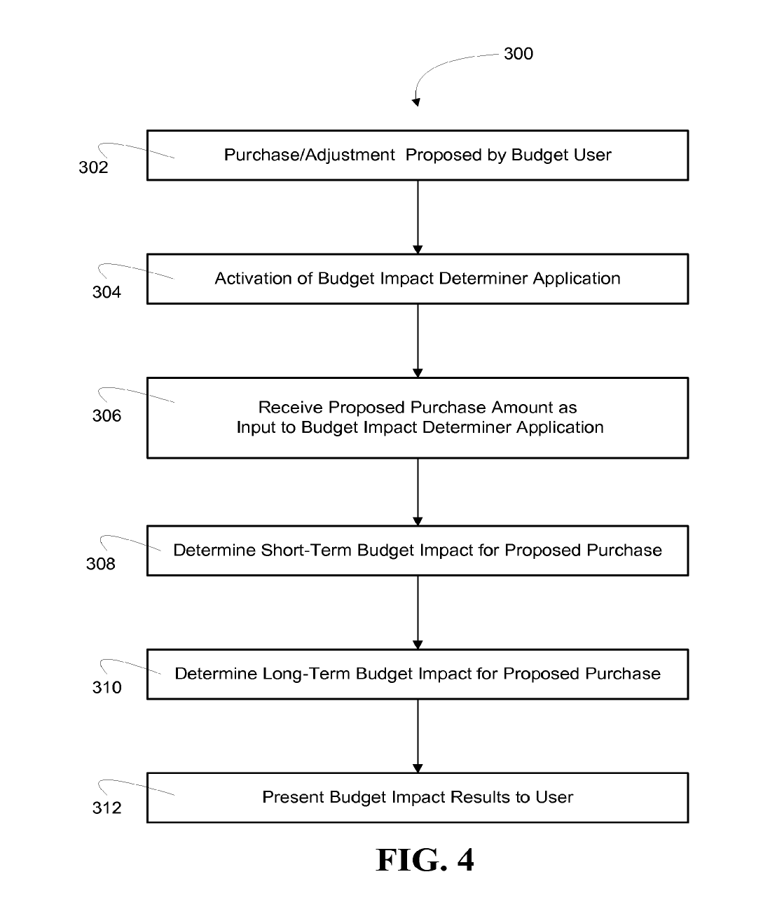

Referring to FIG. 4, a flow diagram is depicted of a method 300 for budget impact determination, in accordance with an embodiment of the present invention. At Event 302, the budget system user is presented with a proposed expenditure or an adjustment to a pre-existing expenditure, such as a change in a mortgage payment or the like. At Event 304, based on the proposed expenditure, the user activates a budget impact determiner application. It should be noted that while the illustrated flow requires an expenditure or expenditure adjustment to be proposed or otherwise contemplated by the budget user, in practice and within the context of the invention, the budget impact determiner application can be accessed at any point in time by the user, prior to an expenditure or after an expenditure has been undertaken. In one embodiment of the invention, the budget impact determiner application is accessible via the user's hand-held device, such as a cellular telephone; as such, the user may access the application at a point-of-sale, such as a retail outlet, prior to making a purchase to assess the budgetary impact of the purchase.

At Event 306, the proposed expenditure amount or expenditure adjustment is inputted into the budget impact determiner application. It should be noted that one alternate embodiment of the application provides for the application to logically determine recurring expenditures, which, once determined, provide for the automatic launch of the budget impact determiner application and the automatic input of the recurring expenditure amount, such that the application automatically determines the budget impact of the recurring purchase and presents the results to the user.

At Event 308, the application determines the short-term budget impact of the expenditure. The short-term budget impact may be any short-term period as defined by the user or the system. For example, the short-term period may be a month, a portion of the month, a year or a portion of the year. At Event 310, the application determines the long-term budget impact of the expenditure. The long-term budget impact may be any long-term period as defined by the user or the system. For example, the long-term period may be a year, or any period greater than a year. At Event 312, the results of the budget impact determination are presented to the user or otherwise communicated to the user.

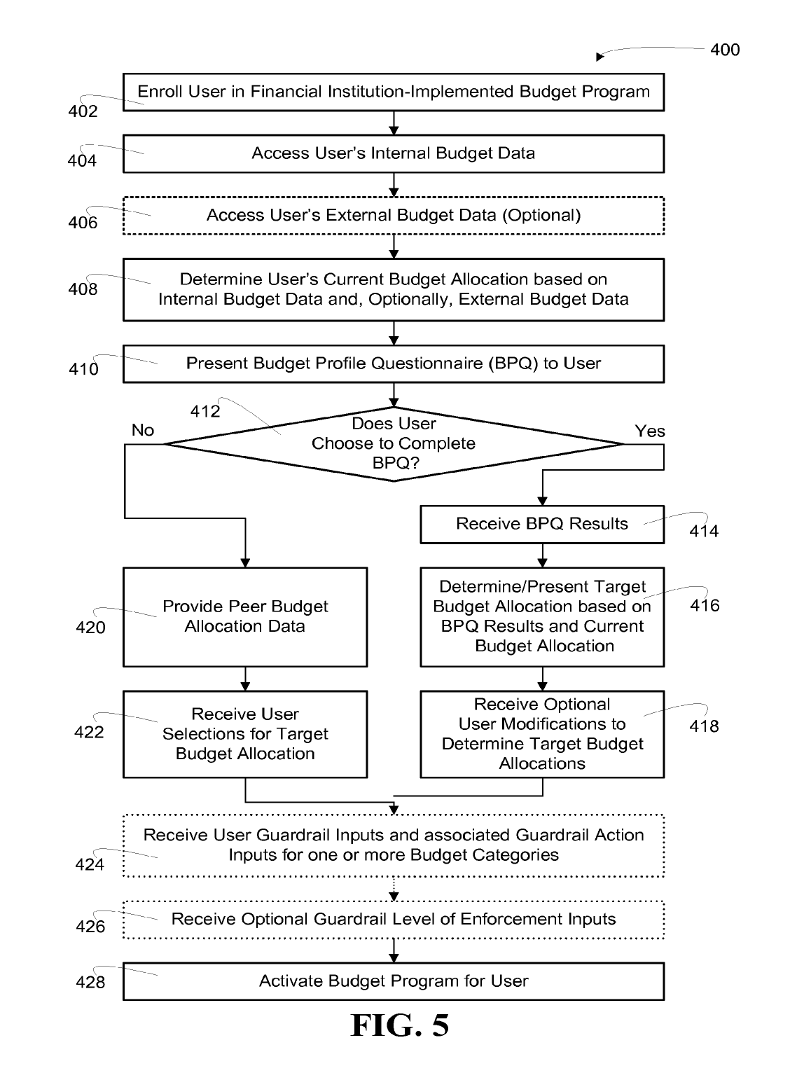

Referring to FIG. 5, a flow diagram is presented of a method 400 for determining a user's target budget allocation and defining guardrails, in accordance with present embodiments of the invention. At Event 402 the user enrolls in financial institution-implemented budget program. In most instances, the user may be a pre-existing financial institution customer, and, in some embodiments, being a financial institution customer may be a pre-requisite to being afforded enrollment in the budget program. According to embodiments of the invention, enrollment, configuration of the user budget criteria and budget tracking information may be provided to the user via a network interface, such as an online website or the like. In one specific embodiment, the configuration of the user budget criteria and/or budget tracking information may be accessible online via the financial institution's online banking site.

At Event 404, once the user has enrolled in the budget system, the budget system accesses internal financial institution databases, such as customer portfolio databases, to retrieve budget-related information from the user's portfolio, such as account information and the like. The budget-related information may include customer transaction data, such as transaction receipts for electronic purchases, such as debit or credit purchases.

At optional Event 406, the budget system may access external databases, such as other financial institution databases, credit card company databases or the like, in an attempt to retrieve other budget-related information associated with the user. By accessing, retrieving and subsequently using external data to determine the current budget information, the current budget allocations are generally more accurate and robust. Additionally, external data may be necessary in instances in which the customer is a new customer, or in instances in which the internal database information is not sufficient to provide an accurate depiction of the user's current budget allocation.

At Event 408, the user's current budget allocation is determined based on the internal financial institution budget-related data and, optionally, the external budget-related data. The current budget allocation breaks down current expenditures on a per category basis: for example, 30% housing, 10% fuel, 5% entertainment, 15% savings and the like.

At Event 410, the customer is presented with a Budget Profile Questionnaire (BPQ) that includes a plurality of budget-related questions. Specifically, one or more questions are related to the customer's current spending habits and one or more questions are related to determining the latent flexibility in the customer's current budget. At Decision 412, a determination is made as to whether the user chooses to complete the BPQ.

If the user chooses to complete the BPQ, at Event 414, BPQ results are received. The results may be weighted based on budget significance and subsequently scored to result in a BPQ score. At Event 416, a target budget allocation is determined based on the BPQ results or BPQ score and the current budget allocation and subsequently presented to the user. Similar to the current budget allocation, the target budget allocation breaks down target expenditures on a per category basis. At Event 418, the user may modify the determined target budget allocations to meet their perceived needs.

If the user chooses not to complete the BPQ, at Event 420, peer budget allocation is presented to the user as a guideline for selecting target budget allocation. The peer data may reflect national averages having or not having similar demographics as the user, financial institution customers having or not having similar demographics as the user, individuals residing proximate the user or the like. At Event 422, user budget allocation selections are received by the user, which serve to define the user's target budget allocation.

At optional Event 424, user guardrail inputs and associated guardrail action inputs are received for one or more of the categories in the target budget allocation. As previously noted, the guardrail defines an expenditure limit at which the associated guardrail action may occur. In accordance with embodiments of the invention, the guardrail may be set at, below or above the target budget allocation for the category. The guardrail action may include, but is not limited to, a guardrail alert and/or a guardrail penalty or the like.

At optional Event 426, one or more user configurable guardrail parameters are received. The guardrail parameters may affect the guardrail limit and/or the guardrail action. For example, the guardrail may define a parameter that defines when the associated action should occur, for example, when the guardrail is met/exceeded or when expenditures are within a predetermined guardrail range. The guardrail action parameters are generally guardrail action specific. For example, if the guardrail action is a guardrail alert, a guardrail parameter may further define a user chosen communication mechanism, and/or a guardrail parameter may define a user selected frequency for communicating the alert once the guardrail has been met, or once the expenditures are within the predetermined guardrail range. If the guardrail action is a guardrail penalty, the guardrail parameter may define the type and/or amount of the penalty. For example, the guardrail penalty may be a contribution to a specified customer account or a contribution to a designated charity. Alternatively, the guardrail penalty may define further spending limitations for the category of interest, or a spending prohibition for the category of interest.

At Event 428, once the target budget has been determined or selected and any optional guardrails are set, the budget program is activated for the user and begins tracking expenditures as they pertain to the target budget allocations, tracking expenditures as they pertain to the guardrails and initiating the guardrail action if a guardrail is met, or if expenditures are within the predefined guardrail range.

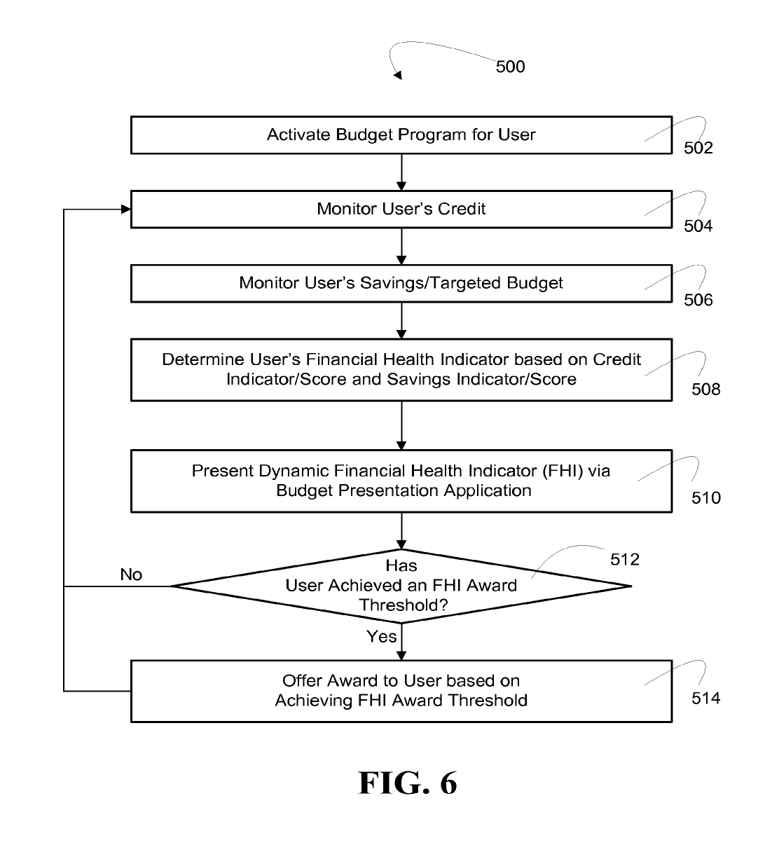

Turning the reader's attention to FIG. 6, a method 500 is detailed for determining a financial health indicator for a user of an associated budget system, in accordance with an embodiment of the present invention. At Event 502, the budget system is activated for a user. Activation is typically preceded by determining or selecting a target budget allocation and, optionally, defining guardrails and associated guardrail actions for one or more target budget allocation categories.

At Event 504, the user's credit is dynamically monitored or otherwise tracked. Credit monitoring may include monitoring a user's credit score as provided by one or more credit reporting bureaus. In one embodiment of the invention a plurality of user credit scores are monitored from different credit reporting bureaus, subsequently weighted to allow for a difference in the score and averaged to determine a collective credit score for the budget user.

At Event 506, the user's savings (i.e., the user's ability to stay on budget) is dynamically monitored or otherwise tracked. The user's savings indicator may be based on short-term savings or long-term savings or any combination of both. The savings indicator may provide for an overall savings score or the like.

At Event 508, a financial health indicator is determined for the user based on the credit indicator/score and the savings indicator/score. It should be noted that the financial health indicator may be based on factors other than the credit indicator/score and the savings indicator/score. In one specific embodiment, the financial health indicator is based on a ratio of about 70% credit indicator/score and about 30% savings indicator/score. The financial health indicator may be a numeric score, an alphabetic grade, a color on a color scale or the like.

At Event 510, the dynamic financial health indicator is presented to the user via a budget presentation (i.e., Graphical User Interface (GUI)) application. According to one embodiment, the financial health indicator may be presented to the user online via a budget system portal or the like. In other embodiments, the financial health indicator may be provided via a widget that runs on a dashboard-type budget application, As such, the financial health indicator may be provided to the user via any wired and/or wireless networked device, including, but not limited to, a PC, a laptop, a hand-held device, such as a cellular telephone or the like. The dynamic nature of the financial health indicator means that the indicator may fluctuate in real-time or near-real-time based on current expenditures made by the user.

At optional Decision 512, if the financial health indicator is associated with a rewards program, a determination may be continually made to determine if the user's financial health indicator has risen to a level (i.e., met a threshold or sustained a threshold for a predetermined period of time) to warrant a reward. Rewards may include, but are not limited to, better rates of return on a financial institution account, better pricing on financial institution services and/or products, a reward gift or the like. If a determination is made that the financial health indicator has risen to a reward level, at Event 514, the reward is automatically provided to or offered to the user or a determination is automatically triggered to determine if the user otherwise qualifies for the designated reward. If a determination is made that the financial health indicator has not risen to the reward level, the process returns to Event 504 for further tracking of the credit indicator/score and savings indicator/score and dynamic determination of the financial health indicator based on the tracked credit indicator/score and savings indicator/score.

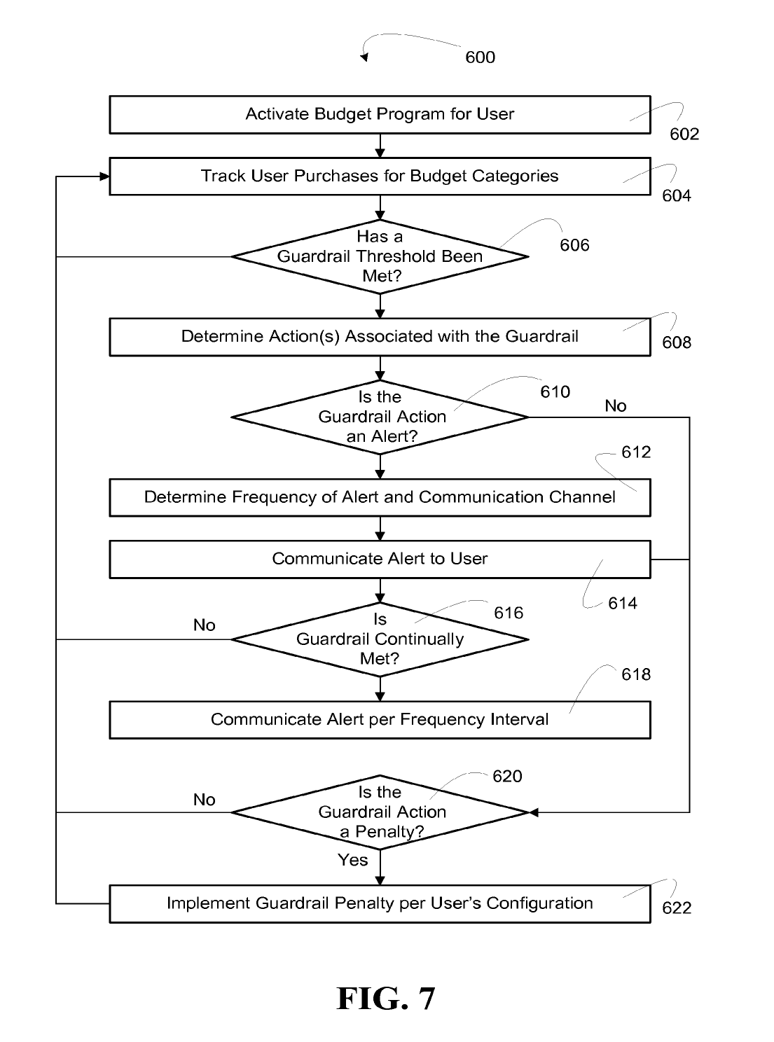

Referring to FIG. 7, a method 600 is provided for tracking guardrails and implementing the action associated with a guardrail in the event the guardrail is achieved, in accordance with embodiments of the present invention. At Event 602, the budget tracking program is activated for a specified user. As described in the flow diagram of FIG. 5, activation of the user is preceded by determination and/or selection of a target budget allocation and selection of guardrails and actions associated with the guardrails. At Event 604, the user's purchases and/or expenditures are tracked for budgeting purposes and applied to the plurality of budget categories.

At Decision 606, a determination is made as to whether a guardrail has been achieved or, if so configured, whether expenditures are within a specified predetermined range of a guardrail that prompts a guardrail action. If the guardrail has not been achieved or otherwise met, the flow returns to Event 602 for further tracking of user's purchases and expenditures. If a guardrail has been determined to be met, then at Event 608, the action or actions associated with the guardrail are determined.

At Decision 610, a determination is made as to whether the guardrail action is an alert. If the guardrail action is determined to be an alert, then at Event 612, the frequency of the alert is determined and the communication channel for the alert is determined. The frequency of the alert and/or the communication channel for the alert may be user-configured or configured within the budget system. Frequency of the alert pertains to how frequently the alert will be communicated to the user during the current budget period, for example, during the current month, once the guardrail has been achieved, or once expenditures are within the predetermined range for prompting guardrail action. The communication channel may be an online communication, email communication, SMS/text communication, voice mail communication or the like. In one embodiment of the invention, the user may configure the budget system to communicate the alert via more than one communication channel. At Event 614, the alert is communicated to the user via the designated communication channel.

At Decision 616, a determination is made as to whether the guardrail threshold is continually being achieved. In some instances, it may be possible to achieve a guardrail for a specified budget period and subsequently fall below the guardrail, for example, if negative expenditures occur in the category in which the guardrail was achieved. If the guardrail is no longer being achieved, then the flow returns to Event 604 for further tracking of user expenditures. If the guardrail continues to be achieved (i.e., the guardrail threshold is met), then at Event 618, the alert is communicated to the user at the predefined frequency interval.

If a determination is made that the guardrail action is or is not an alert, at Decision 620, a determination is made as to whether the guardrail action is a penalty. It should be noted that while the flow diagram of FIG. 7 is limited to guardrail actions being alerts and/or penalties, it is possible and within the confines of the present invention for the guardrail action to be any other action aside from an alert or penalty. As previously noted the penalty may come in the form of a contribution to a user's financial institution account, such as a savings account, an IRA or the like, a contribution to a designated charity, or a prohibition or limitation of further spending in the category associated with the guardrail. If the guardrail action is determined to be a penalty, then at Event 622, the penalty is implemented per the user's configuration as to the type of penalty and the amount or severity of the penalty. If the guardrail action is determined to not be a penalty, the flow returns to Event 604 for further tracking of the user's expenditures.

Referring to FIG. 7, a flow diagram is depicted of a method 600 for budget impact determination, in accordance with an embodiment of the present invention. At Event 602, the budget system user is presented with a proposed expenditure or an adjustment to a pre-existing expenditure, such as a change in a mortgage payment or the like. At Event 604, based on the proposed expenditure, the user activates a budget impact determiner application. It should be noted that while the illustrated flow requires an expenditure or expenditure adjustment to be proposed or otherwise contemplated by the budget user, in practice and within the context of the invention, the budget impact determiner application can be accessed at any point in time by the user, prior to an expenditure or after an expenditure has been undertaken. In one embodiment of the invention, the budget impact determiner application is accessible via the user's hand-held device, such as a cellular telephone; as such, the user may access the application at a point-of-sale, such as a retail outlet, prior to making a purchase to assess the budgetary impact of the purchase.

At Event 606, the proposed expenditure amount or expenditure adjustment is inputted into the budget impact determiner application. It should be noted that one alternate embodiment of the application provides for the application to logically determine recurring expenditures, which, once determined, provide for the automatic launch of the budget impact determiner application and the automatic input of the recurring expenditure amount, such that the application automatically determines the budget impact of the recurring purchase and presents the results to the user.

At Event 608, the application determines the short-term budget impact of the expenditure. The short-term budget impact may be any short-term period as defined by the user or the system. For example, the short-term period may be a month, a portion of the month, a year or a portion of the year. At Event 610, the application determines the long-term budget impact of the expenditure. The long-term budget impact may be any long-term period as defined by the user or the system. For example, the long-term period may be a year, or any period greater than a year. At Event 612, the results of the budget impact determination are presented to the user or otherwise communicated to the user.

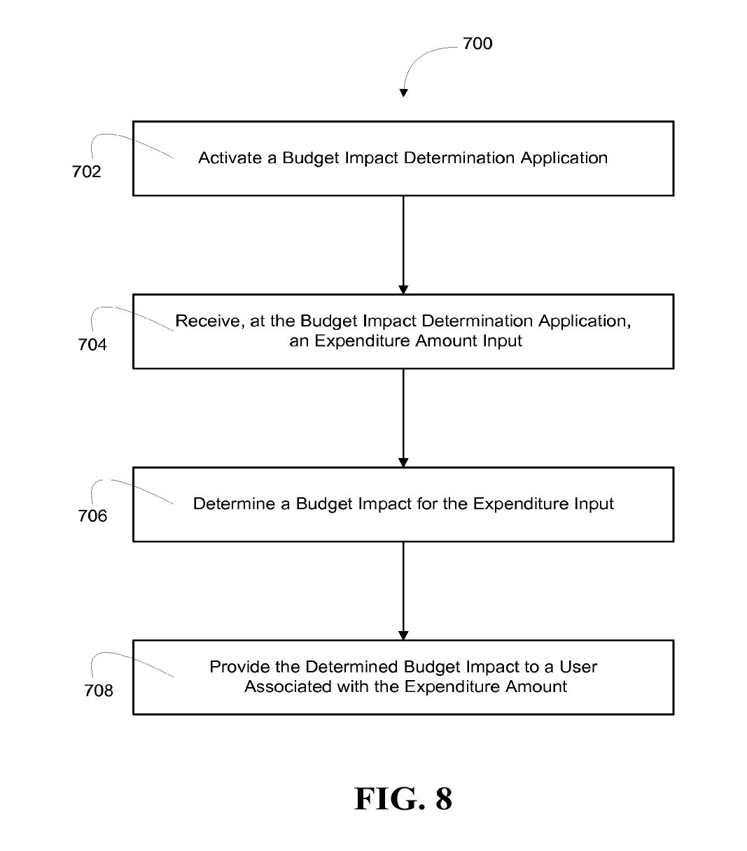

Referring now to FIG. 8 a method 700 is provided for budget impact determination, in accordance with other embodiments of the present invention. At Event 702, the budget impact determination application is activated. The application may be activated manually, on-demand by a budget system user or the application may be activated automatically by the budget system provider. In one embodiment, the application is activated automatically based on determination of a recurring expenditure. In such embodiments, the application is activated automatically and budget impact is determined automatically for the determined recurring expenditure. The budget impact application may be a network-based application that is accessible to a budget user via an online budget system-provider website, for example a financial institution online banking website or the like. In other embodiments, the application may reside on the user's device, such as a PC, a laptop or a handheld computing device, such as a cellular telephone, PDA or the like.

At Event 704, an expenditure amount input is received at the budget impact determination application. The expenditure amount may coincide with a purchase amount, a contemplated purchase amount, a cost adjustment to a preexisting continual payment, such as a mortgage, rental or loan payment or any other type of expenditure in existence or contemplated.

At Event 706, a budget impact is determined for the expenditure amount input. In one embodiment of the invention, the budget impact is a savings amount based on foregoing and/or limiting the expenditure. In accordance with certain embodiments, the budget impact may be short-term budget impact and/or long-term budget impact. The determination of the budget impact may rely on the user's current tracked expenditures in the budget category of interest and the user's current target budget allocation for the category of interest and overall the overall budget.

At Event 708, the determined budget impact is provided to the user of the budget system. In some embodiments, the user will be presented the budget impact via a display on the device at which the budget impact determination application resides or is being accessed. In other embodiments, the budget impact may be communicated to the user via email, SMS/text or the like as configured by the budget system and/or by the budget system user.

Thus, methods, systems, computer program products and the like provide for budget impact determination for expenditures being made or contemplated by a user of budget tracking system. The budget impact determination application is made readily available to users on-demand either via a budget tracking website or executable on the user's device as a widget in dashboard-type application. The on-demand aspect of the budget impact determination application allows for the user to determine both short-term and long-term budget implications prior to making a purchase. In this regard, a user may be deterred from making impulse purchases that would negatively impact the user's target budget allocation.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing a financial health indicator, the method comprising:
providing a credit report score and a budget indicator for a user;
determining the user's financial health indicator based on the user's credit report score and the user's budget indicator;
in response to a user conducting an expenditure, automatically receiving, via a computing device, an input that indicates that the user has conducted the expenditure, wherein the input includes an expenditure amount and a merchant with whom the expenditure was conducted;
in automatic response to receiving the input, accessing, via a computing device processor, a financial institution database that includes historical transactional data associated with the user;
determining, via a computing device processor, that the expenditure is a recurring expenditure based on comparing the expenditure amount and the merchant to the historical transactional data in the financial institution database, wherein the expenditure is determined to be a recurring expenditure if the historical transaction data indicates a predetermined number of similar expenditure amount transactions with the merchant within a predetermined period of time;
in automatic response to determining the recurring expenditure, determining, via a computing device processor, a budget impact for the recurring expenditure, wherein the budget impact includes a (1) a long-term savings amount based on foregoing the recurring expenditure for a year, and (2) a short-term savings amount based on foregoing the recurring expenditure for a period of time less than a year; and
in automatic response to determining the budget impact, communicating, via a computing device user interface, the determined budget impact including the long-term savings amount and short-term savings amount to the user associated with the expenditure amount, wherein the determined budget impact is communicated to the user at a time when the expenditure occurs.

2. The method of claim 1, wherein determining the financial indicator of a budget impact further comprises determining a short-term budget impact for the recurring expenditure based on a target budget allocation predefined by the user, wherein short-term is defined as less than a year.

3. The method of claim 2, wherein determining the short-term budget impact further comprises determining the short-term budget impact within a user-defined budget category associated with the recurring expenditure.

4. The method of claim 1, wherein determining a budget impact further comprises determining a long-term budget impact for the recurring expenditure based on a target budget allocation predefined by the user, wherein long-term is defined as a year or greater.

5. The method of claim 4, wherein determining a long-term budget impact further comprises determining the long-term budget impact within a user-defined budget category associated with the recurring expenditure.

6. An apparatus for budget impact determination, the apparatus comprising:
a computer platform including at least one processor and a memory;
a financial health indicator module stored in said storage device and executable by the processor to provide a credit report score and a budget indicator for a user and determine the user's financial health indicator based on the user's credit report score and the user's budget indicator; and
a budget module stored in the memory, executable by the processor and operable to track expenditures for users, wherein the budget module comprises:
a budget impact determination application operable to (1) automatically receive, in response to a user conducting an expenditure, an input that indicates that the user has conducted the expenditure, wherein the input includes an expenditure amount and a merchant with whom the expenditure was conducted, (2) in automatic response to receiving the input, access a financial institution database that includes historical transactional data associated with the user, (3) determine that the expenditure is a recurring expenditure based on comparing the expenditure amount and the merchant to the historical transactional data in the financial institution database, wherein the expenditure is determined to be a recurring expenditure if the historical transaction data indicates a predetermined number of similar expenditure amount transactions with the merchant within a predetermined period of time, (4) in automatic response to determining the recurring expenditure, determine a budget impact for the recurring expenditure and (5) in automatic response to determining the budget impact, communicate electronically, at a time when the expenditure occurs, the determined budget impact to the user associated with the expenditure amount,
wherein the budget impact includes a (1) a long-term savings amount based on foregoing the recurring expenditure for a year, and (2) a short-term savings amount based on foregoing the recurring expenditure for a period of time less than a year.

7. The apparatus of claim 6, wherein the budget impact determination application is further operable to determine a short-term budget impact for the recurring expenditure based on a predefined target budget allocation associated with the user.

8. The apparatus of claim 7, wherein the budget impact determiner application is further operable to determine the short-term budget impact within a user-defined budget category associated with the recurring expenditure.

9. The apparatus of claim 6, wherein the budget impact determiner application is further operable to determine a long-term budget impact for the recurring expenditure based on a predefined target budget allocation associated with the user.

10. The apparatus of claim 9, wherein the budget impact determiner application is further operable to determine the long-term budget impact within a user-defined budget category associated with the recurring expenditure.

11. The apparatus of claim 6, wherein the budget impact determiner application is further operable to be activated, manually based on an on-demand user input.

12. A computer program product comprising:
a non-transitory computer-readable medium comprising:
a first set of codes for causing a computer to determine a user's financial health indicator based on a user's credit report score and a user's budget indicator;
a second set of codes for causing a computer to, in response to a user conducting an expenditure, automatically receive an input that indicates that the user has conducted the expenditure, wherein the input includes an expenditure amount and a merchant with whom the expenditure was conducted;
a third set of codes for causing a computer to, in automatic response to receiving the input, access a financial institution database that includes historical transactional data associated with the user;
a fourth set of codes for causing a computer to determine that the expenditure is a recurring expenditure based on comparing the expenditure amount and the merchant to the historical transactional data in the financial institution database, wherein the expenditure is determined to be a recurring expenditure if the historical transaction data indicates a predetermined number of similar expenditure amount transactions with the merchant within a predetermined period of time;
a fifth set of codes for causing a computer to, in automatic response to determining the recurring expenditure, determine a budget impact for the recurring expenditure, wherein the budget impact includes a (1) a long-term savings amount based on foregoing the recurring expenditure for a year, and (2) a short-term savings amount based on foregoing the recurring expenditure for a period of time less than a year; and
a sixth set of codes for causing a computer to, in automatic response to determining the budget impact, communicate the determined budget impact including the long-term savings amount or short-term savings amount to the user associated with the expenditure amount, wherein the determined budget impact is communicated to the user at a time when the expenditure occurs.

13. The computer program product of claim 12, wherein the fourth set of codes is further operable to cause the computer to determine a short-term budget impact for the recurring expenditure based on a target budget allocation predefined by the user.

14. The computer program product of claim 13, wherein the fourth set of codes is further operable to cause the computer to determine the short-term budget impact within a user-defined budget category associated with the recurring expenditure.

15. The computer program product of claim 12, wherein the fourth set of codes is further operable to cause the computer to determine a long-term budget impact for the recurring expenditure based on a target budget allocation predefined by the user.

16. The computer program product of claim 15, wherein the fourth set of codes is further operable to cause the computer to determine the long-term budget impact within a user-defined budget category associated with the recurring expenditure.
